(19) United States
(12) Patent Application Publication
(10) Pub. No.: US 2007/0280858 A1
(43) Pub. Date: Dec. 6, 2007

(54) Microchannel device

(75) Inventors: Daisuke Nakayama, Kanagawa (JP); Ryojiro Akashi, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/594,058

(22) Filed: Nov. 8, 2006

(30) Foreign Application Priority Data
May 30, 2006 (JP) 2006-149596

(51) Int. Cl. B01L 3/02

(52) U.S. Cl. 422/100

(57) ABSTRACT

A microchannel device includes: a microchannel that comprises a stimuli-sensitive gel and is adjusted by giving a stimulation species to the stimuli-sensitive gel.

### BACKGROUND

1. Technical Field

The present invention relates to a microchannel device.

2. Related Art

The fine elements or devices are typified in the microreactor that is defined as the “device that is manufactured by utilizing the fine patterning and produces a reaction in the microchannel whose equivalent diameter is 500 μm or less”. In common, these fine elements or devices possess many advantages such as small-lot production of a wide variety of products, high efficiency, low environmental burden, and the like when they are applied to the technology to execute analysis, synthesis, extraction, or separation of the material, for example. Therefore, their application to various fields is expected nowadays.

A higher function can be attached to the element or device by incorporating a means such as a valve, or the like, which fulfills a role to control a flow, into the microchannel of the microreactor, or the like. Because such microvalve has moving portions, high precision and durability are demanded of the microvalve. However, it is difficult to get the approach through which the microchannel is processed in the microvalve, and therefore a practical approach has not been implemented.

### SUMMARY

According to an aspect of the present invention, a microchannel device includes: a microchannel that comprises a stimuli-sensitive gel and is adjusted by giving a stimulation species to the stimuli-sensitive gel.

### BRIEF DESCRIPTION OF THE DRAWINGS

Exemplary embodiment of the present invention will be described in detail based on the following figures, wherein:

FIG. 1 is a schematic sectional view showing an example of a microchannel device of the present invention, on an inner wall of a microchannel of which a stimuli-sensitive gel is modified.

FIG. 2 is a schematic sectional view showing an example of a microchannel device of the present invention, a microchannel of which is formed of a stimuli-sensitive gel; and

FIG. 3 is a schematic sectional view showing an example of a microchannel device of the present invention, on an inner wall of a Y-shaped microchannel of which a stimuli-sensitive gel is modified.

### DETAILED DESCRIPTION

A microchannel device of the present invention, includes a microchannel on at least a part of an inner wall of which a stimuli-sensitive gel is modified by a chemical bond, or a microchannel formed of the stimuli-sensitive gel; wherein a sectional area of the microchannel is adjusted by a stimulation given to the stimuli-sensitive gel.

According to the microchannel device of the present invention, a sectional area of a microchannel through a simple approach can be provided can be controlled.

Also, according to an embodiment of the microchannel device of the present invention, preferably a microchannel device having a valve function that can open/close reversibly a microchannel or adjust the microchannel at any flow rate can be provided, a microchannel device capable of forming a valve in a desired any position can be provided, a microchannel device capable of forming valves simultaneously in plural positions can be provided, or a microchannel device capable of adjusting a flow rate on a non-contact basis can be provided, for example.

The present invention will be explained in detail with reference to the drawings, and others hereinafter.

### (Microchannel Device)

An embodiment of the microchannel device of the present invention provides a microchannel device that has a microchannel on at least a part of an inner wall of which a stimuli-sensitive gel is modified by a chemical bond.

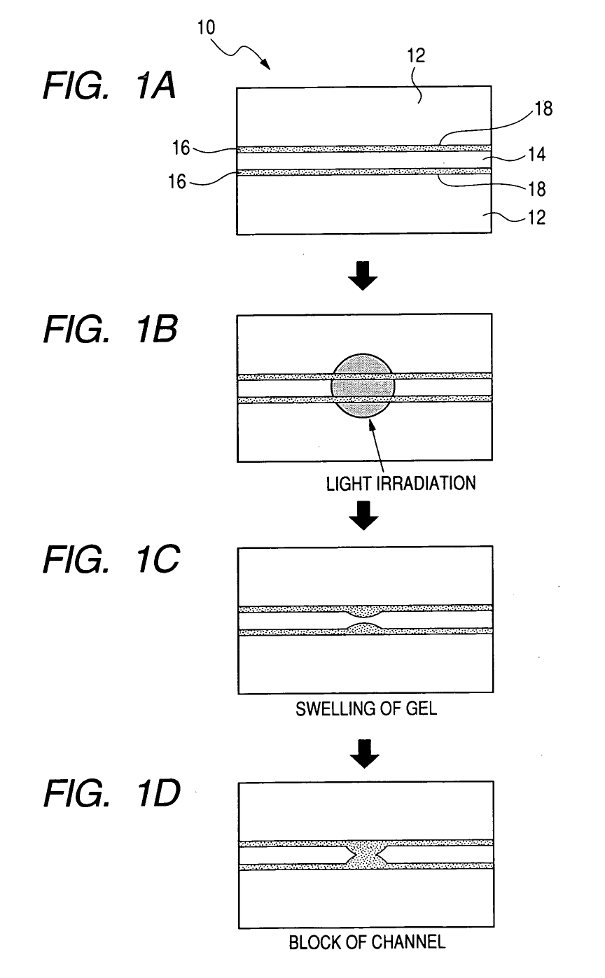

FIG. 1 is a schematic sectional view showing an example of a microchannel device having a microchannel, on at least a part of an inner wall of which a stimuli-sensitive gel is modified by a chemical bond.

The microchannel device of the present invention shown in FIG. 1 includes a microchannel 10 that has a wall portion 12 and a channel portion 14. A stimuli-sensitive gel 16 is bonded to an inner wall 18 of the microchannel 10 by a chemical bond (FIG. 1A).

In the case where a stimuli-sensitive gel that swells by a light absorption is used as the stimuli-sensitive gel 16, when a light is irradiated onto a part of the microchannel 10 that is filled with a liquid, a portion of the stimuli-sensitive gel 16 onto which the light is irradiated absorbs the liquid and then swells, and then a sectional area of the channel portion 14 is reduced or the channel portion 14 is blocked, as shown in FIG. 1B to FIG. 1D.

Also, another embodiment of the microchannel device of the present invention provides a microchannel device having a microchannel that is formed of the stimuli-sensitive gel.

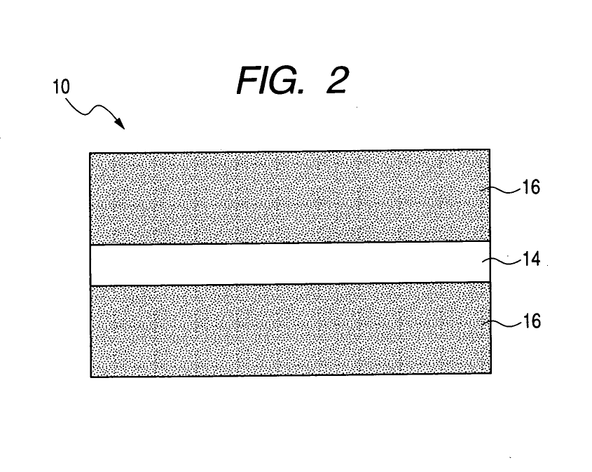

FIG. 2 is a schematic sectional view showing an example of a microchannel device of the present invention having a microchannel formed of a stimuli-sensitive gel.

The microchannel device 10 of the present invention shown in FIG. 2 is formed by using the stimuli-sensitive gel 16 as a base material of the microchannel.

For example, like FIG. 1, in the case where the stimuli-sensitive gel that swells by a light absorption is used as the stimuli-sensitive gel, when a light is irradiated onto a part of the microchannel that is filled with a liquid, the stimuli-sensitive gel 16 onto a portion of which the light is irradiated absorbs the liquid and then swells, and then the microchannel can be blocked.

When the microchannel device of the present invention has the microchannel on at least a part of the inner wall of which the stimuli-sensitive gel is modified by the chemical bond, preferably the amount of the stimuli-sensitive gel used can be easily adjusted to a amount required, and also this microchannel device is excellent in cost.

Also, because the gel is modified on the inner wall by the chemical bond, peeling of the gel from the inner wall caused by the repetition of swelling/shrinkage of the gel can be prevented.

Also, when the microchannel device of the present invention has the microchannel formed of the stimuli-sensitive gel, preferably the steps of manufacturing the microchannel device can be simplified.

In the microchannel device of the present invention, only one type of stimuli-sensitive gel may be employed in one device or plural types of stimuli-sensitive gels may be employed in one device.

The stimuli-sensitive gel applicable in the present invention is such a gel that, when a stimulation such as a change in pH, a change in ion concentration, adsorption/desorption of a chemical material, a change in solvent composition, or an application of magnetic field, light, heat (temperature change), electric current, electric field, or the like is given to such gel, it adsorbs/desorbs (absorbs/releases) a liquid to change its volume (swell/shrink).

It is preferable that the stimulation species of the stimuli-sensitive gel should be selected from a group consisting of light, electricity (electric current or electric field), any chemical species, and temperature change (heat) among the above stimulations because their stimulation applying means are simple.

In the present invention, both irreversible and reversible changes may be employed as a volumetric change of the stimuli-sensitive gel, but preferably the reversible change may be employed. Also, preferably the stimuli-sensitive gel should be formed of a polymer gel having stimulation sensitivity.

As the stimuli-sensitive gel that is stimuli-sensitive to a change of an ion concentration, the ionic polymer material (polymer gel) similar to the stimuli-sensitive gel that is sensitive to a change of pH can be used. Also, preferably a change of an ion concentration should be made by adding salt, etc., using the ion-exchange resin, or the like.

As the stimuli-sensitive gel that is stimuli-sensitive to adsorption/desorption of chemical material, strong ionic polymer gel is preferable. As the example, bridged material of polyvinylsulfonic acid, bridged material of copolymer consisting of vinylsulfonic acid and (meta)acrylamide, hydroxyethyl(meta)acrylate, alkylester (meta)acrylate, or the like, bridged material of polyvinyl benzenesulfonic acid, bridged material of copolymer consisting of vinyl benzenesulfonic acid and (meta)acrylamide, hydroxyethyl(meta)acrylate, alkylester (meta)acrylate, or the like, bridged material of poly(meta)acrylamide alkylsulfonic acid, bridged material of copolymer consisting of (meta)acrylamide alkylsulfonic acid and (meta)acrylamide, hydroxyethyl(meta)acrylate, alkylester (meta)acrylate, or the like, etc. are listed. In particular, polyacrylamide alkylsulfonic acid system polymer is preferably used.

Also, as the chemical material in this case, preferably a surfactant, e.g., a cationic surfactant such as alkyl pyridine salt like n-dodecylpyridinium chloride, alkyl ammonium salt, phenyl ammonium salt, phosphonium salt like tetraphenylphosphonium chloride, or the like can be used.

Also, as the stimuli-sensitive gel that is stimuli-sensitive to adsorption/desorption of the chemical material, the bridged material of copolymer consisting of phenylboronic acid monomer and ethylene unsaturated monomer, which is the stimuli-sensitive gel that is stimuli-sensitive to adsorption/desorption of diol compound, sugar, polyhydric alcohol compound like nucleotide, or the like. Also, as such stimuli-sensitive gel, the stimuli-sensitive gels set forth in JP-A-7-304971, JP-A-11-322761, and JP-A-2000-309614 can be exemplified.

As the phenylboronic acid monomer, preferably 4-(dihydroxyborono)styrene, 3-(meta)acrylamide phenylboronic acid, N-(4′-vinylbenzyl)-4-phenylboronic acid carboxyamide 3-((meta)acrylamidyl glycylamide) phenylboronic acid, 3-(meta)acrylamide-2-trifluoromethyl phenylboronic acid, 3-(meta)acrylamide-4-pentafluoroethyl phenylboronic acid, 3-(meta)acrylamide-6-heptafluoropropyl phenylboronic acid, 3-(meta) acrylamide-4,6-bis(heptafluoropropyl)phenylboronic acid, 3-(meta)acrylamide-2-(1,1,2,2,3,3-hexafluoropropyl)phenylboronic acid, 3-(meta)acrylamide-4-(1-chloro-1,1,2,2,3,3-hexafluoropropyl)phenylboronic acid, 3-(meta)acrylamide-6-(perfluoro-1,4-dimethyl-2,5-dioxaoctyl)phenylboronic acid, and the like can be exemplified.

As the ethylene unsaturated monomer, preferably N-alkyl substitution (meta)acrylamide, (meta)acrylamide, hydroxyethyl (meta)acrylamide, alkylester (meta)acrylate, (meta)acrylate, and the like are listed.

As the stimuli-sensitive gel that is stimuli-sensitive to a change of solvent composition, most of polymer gels are listed. The swelling and shrinkage can be caused by utilizing a good solvent and a poor solvent of the polymer gel.

As the stimuli-sensitive gel that is stimuli-sensitive to an application of the magnetic filed, the bridged material of poly(vinyl alcohol) having ferromagnetic particles and magnetic fluid, and the like are listed. In this case, the gel itself is not particularly restricted if such gel is stimuli-sensitive to the magnetic filed. Any gel may be used if such gel is contained in a category of the gel.

As the stimuli-sensitive gel that is stimuli-sensitive to an application of the electric current or the electric field, preferably the CT complex (charge-transfer complex) of the cationic polymer gel and the electron accepting compound is employed. Also, bridged material of amino substitution (meta)acrylamide such as dimethylamino propyl(meta)acrylamide, or the like, bridged material of (meta)aminoacrylate substitution alkylester such as dimethylamino ethyl(meta) acrylate, diethylamino ethyl(meta) acrylate, dimethylamino propyl acrylate, or the like, bridged material of polystyrene, bridged material of poly(vinylpyridine), bridged material of poly(vinylcarbazole), bridged material of polydimethylaminostyrene, and the like are listed. In particular, preferably dialkylamino alkyl(meta)acrylate polymer such as dimethylamino propyl acrylate, diethylamino ethyl(meta) acrylate, diethylamino propyl(meta)acrylate, and the like are employed. These can be employed in combination with the electron accepting compound such as benzoquinone, 7,7,8,8-tetracyanoquinodimethane (TCNQ), tetracyanoethylene, chloranil, trinitrobenzene, maleic anhydride, iodine, or the like.

As the stimuli-sensitive gel that is stimuli-sensitive to an application of the light, preferably the bridged material of hydrophilic high-molecular compound such as triarylmethane derivative, spirobenzopyran derivative, or the like having the group that dissociates ions in response to a light. As the example, the bridged material of copolymer consisting of vinyl substitution triarylmethaneleuco derivative and (meta)acrylamide, and the like can be listed.

Also, as the stimuli-sensitive gel that is stimuli-sensitive to an application of the light, preferably the bridged material of polymer compound having the group such as the compound having azo group (particularly azobenzene structure), or the like that causes cis-trans isomerization by a light, and the like are preferable. As the example, the bridged material of copolymer consisting of azobeneze containing (meta)acryloyl group and (meta)acrylamide, and the like are listed.

As the stimuli-sensitive gel that is stimuli-sensitive to the heat (temperature change), the bridged material of polymer with LCST (Lower Critical Solution Temperature) having such a property that this gel is flocculated at a certain temperature, or more by a hydrophobic interaction and deposited from an aqueous solution, the bridged material of polymer, the bridged material of polymer with UCST (Upper Critical Solution Temperature), the polymer gel having the polymer chains that are hydrogen-bonded mutually, the IPN (Interpenetrating network) of polymer having two components that are hydrogen-bonded mutually, the polymer gel having cohesive side chains such as crystallinity, or the like, and the like are preferable. Particularly the LCST gel utilizing the hydrophobic interaction is preferable among them. The LCST gel contracts at a high temperature, and conversely the UCST gel, the IPN gel and the crystal gel have such a property that swells at a high temperature.

As the concrete compound of the gel that contracts at a high temperature, the bridged material of N-alkyl substitution (meta) acrylamide such as poly(N-isopropyl acrylamide), or the like, the bridged material of copolymer having two components or more consisting of N-alkyl substitution (meta)acrylamide and (meta)acrylate and its salt or (meta)acrylamide or methacrylate alkyl ester, and the like, the bridged material of poly(vinyl methyl ether), the bridged material of alkyl substitution cellulose derivative such as methyl cellulose, ethyl cellulose, hydroxypropyl cellulose, or the like, etc. are listed. Among them, poly(N-isopropyl(meta)acrylamide) is preferable.

In contrast, as the concrete compound of the gel that swells at a high temperature, the IPN consisting of the bridged material of poly(meta)acrylamide and the bridged material of poly(meta)acrylate and its partial neutralized substance (substance partially salified in unit of acrylate), the IPN consisting of the bridged material of copolymer containing poly(meta)acrylamide as a principal component and the bridged material of poly(meta)acrylate and its partial neutralized substance, and the like are listed. More preferably, the IPN consisting of the bridged material of poly(N-alkyl substitution alkylamide), the bridged material of poly(meta) acrylamide, and the bridged material of poly(meta)acrylate and its partial neutralized substance, and the like are listed.

Also, as the crystalline gel, the bridged material of copolymer of (meta)acrylate ester having long chain alkyl group such as octyl group, decyl group, lauryl group, stearyl group, or the like and (meta)acrylate and its salt is listed. A temperature (phase transition temperature) indicating a volumetric change of the heat-sensitive polymer gel can be designed variously according to a structure or a composition of the polymer gel. In this case, preferably the phase transition temperature is set within a boiling point and a solidifying point of the solvent, more preferably this temperature is in a range of −30 to 300° C., further preferably this temperature is in a range of −10 to 150° C., and most preferably this temperature is in a range of 0 to 60° C.

As the stimuli-sensitive gel that is stimuli-sensitive to the heat, preferably the gel exhibiting plural phase transition points in response to a temperature change can be employed, in addition to the above concrete examples. When concretely exemplified, the IPN consisting of the bridged material of polyalkyl substitution (meta)acrylamide such as poly N-isopropyl(meta)acrylamide, or the like and poly(meta)acrylate, and the like are listed. It is known that these gels show two phase transition points to swell-shrink-swell according to a temperature rise.

Also, for the purpose of increasing an amount of volume change of the stimuli-sensitive gel that is stimuli-sensitive to the heat, preferably the ionic functional group should be contained in the polymer gel. As the ionic functional group, carboxylic acid, sulfonic acid, ammonium group, phosphoryl group, and the like are listed. The ionic functional group can be contained by the method of copolymerizing the monomer having the functional group in preparing the gel, impregnating the synthesized stimuli-sensitive gel with the monomer to produce the IPN (Interpenetrating Network), converting partially the functional group in the stimuli-sensitive gel by a chemical reaction such as hydrolysis, oxidation reaction, or the like, and the like.

Among them, preferably the bridged material of the polymer compound having the azo group (especially azobenzene structure) as the light-sensitive gel, the bridged material of copolymer consisting of phenylboronic acid monomer and ethylene unsaturated monomer as the diol class-sensitive gel, and the bridged material of N-alkyl substitution (meta)acrylamide copolymer as the electricity, any chemical species and temperature change-sensitive gel are shown as the stimuli-sensitive gel.

When the microchannel device of the present invention has the microchannel on at least a part of the inner wall of which the stimuli-sensitive gel is modified by the chemical bond, preferably an amount of crosslinking agent used in the stimuli-sensitive gel should be set to 0.01% to 10% of a total weight of the monomer, and more preferably an amount of crosslinking agent should be set to 0.1% to 1.0%. When an amount of crosslinking agent is set within the above range, not only an excellent self-sustaining property but also an enough amount of volumetric change can be obtained and also the stimuli-sensitive gel can be modified easily on the inner wall surface of the microchannel.

An amount of maximum change of volume of the stimuli-sensitive gel is not particularly limited, but the higher the better. It is preferable that a volume ratio of a maximum swelling to a minimum shrinkage should be set to 3 or more. In particular, it is preferable that such volume ratio should be set to 5 or more.

Also, either of an irreversible change and a reversible change can be employed as a change of volume of the stimuli-sensitive gel. Preferably the reversible change should be employed from the respect of any flow rate control and reuse of the device.

In addition, it is preferable that an absorbed amount of the liquid at the time of maximum swelling of the stimuli-sensitive gel should be set to (mass of the liquid that the stimuli-sensitive gel absorbs/mass of the stimuli-sensitive gel in its dry condition)=5 to 500. A change of volume of the stimuli-sensitive gel can be sufficiently taken if such ratio is 5 or more, and a strength of the gel can be ensured enoughly if such ratio is 500 or less.

Various stabilizers such as a ultraviolet absorbent, a light stabilizer, and the like can be copolymerized or bonded in the stimuli-sensitive gel inasmuch as its characteristics are not damaged. For example, it can be preferably applied that the hindered amine or hindered phenol compound, the compound having a light stabilizing function, and the like are copolymerized or bonded. It is preferable that an amount of copolymerization or bonding of these compounds should be set to a range of 0.01 to 5 wt % of the stimuli-sensitive gel.

The stimuli-sensitive gel modified on the inner wall of the microchannel is bonded to the inner wall of the microchannel by the chemical bond, and preferably a covalent bond should be used as the chemical bond. Also, when the stimuli-sensitive gel is used as the base material of the microchannel, the surface portion of the inner wall and the inside of the inner wall are formed with the uniform stimuli-sensitive gel, and it is needless to say that they are bonded by the chemical bond.

When the stimuli-sensitive gel is modified on at least a part of the inner wall of the microchannel device by the chemical bond, the stimuli-sensitive gel may be formed to have an adequate thickness at need. In this case, the thickness should be set preferably to 0.01 to 5000 μm, more preferably to 0.1 to 1000 μm, and most preferably to 10 to 300 μm.

Any fluid, even though not a perfect fluid, can be passed through the microchannel device of the present invention. A fluid containing a solid or a gas may be employed according to the using purpose. Also, a composition, a concentration, and the like can be selected at need.

As the material of the microchannel device that can be used in the present invention, the material such as metal, ceramic, glass, silicon, resin, or the like can be illustrated in addition to the stimuli-sensitive gel. Preferably stimuli-sensitive gel, glass, resin, or the like, and the like are listed. When the stimuli-sensitive gel is modified on the inner wall of the microchannel, preferably the glass or the resin should be employed as the material because it can be easily modified on the inner wall.

Also, preferably the glass should be employed as the material from viewpoints of low cost, transparency, workability, and the like. Also, preferably the resin should be employed from viewpoints of moldability, impact resistance, low cost, and the like.

As the glass, the common glass, for example, soda glass, quartz glass, borosilicate glass, crystal glass, or the like can be employed. Also, preferably a glass transition point of the glass should be set to 500 to 600° C.

As the resin, preferably the resin whose impact resistance, thermal resistance, chemical resistance, transparency, or the like is suitable for the aimed reaction, unit operation, or the like should be employed. Concretely, preferably polyester resin, styrene resin, acryl resin, styrene-acryl resin, silicon resin, epoxy resin, diene resin, phenol resin, terpene resin, coumarone resin, amide resin, amide-imide resin, bytyral resin, urethane resin, ethylene-vinylacetate resin, and the like can be listed. More preferably, acryl resin such as methyl methacrylate resin, or the like, styrene resin, etc. should be employed. Also, preferably the resin having a glass transition point should be employed as the resin. Also, preferably the glass transition point should be set in a range of 90 to 150° C., and more preferably such point should be set in a range of 100 to 140° C.

The microchannel is the channel formed in a micro scale. That is, a width of the channel (channel diameter) is less than 5000 μm, and preferably the width is in a range of 10 to 1000 μm and more preferably the width is in a range of 30 to 500 μm. Also, a depth of the channel is almost in a range of 10 to 500 μm. In addition, preferably a length of the channel should be set in a range of 5 to 400 mm, although depending on a shape of the channel to be formed, and more preferably the length should be set in a range of 10 to 200 mm.

Also, a shape of the microchannel is not particularly limited. For example, a sectional shape taken in the direction perpendicular to a flow direction may be shaped into a desired shape such as a circular shape, an elliptic shape, a polygonal shape, or the like.

A size of the microchannel device can be set appropriately in response to the using purpose. Preferably the size should be set in a range of 1 to 100 cm², and more preferably the size should be set in a range of 10 to 40 cm². Also, preferably a thickness of the microchannel device should be set in a range of 2 to 30 mm, and more preferably the thickness should be set in a range of 3 to 15 mm.

The microchannel device of the present invention may have one microchannel on at least a part of the inner wall of which the stimuli-sensitive gel is provided or two microchannels or more, as occasion demands. Also, the microchannel device of the present invention may have a branch of the channel, a junction portion, a microchannel on which no stimuli-sensitive gel is provided, and the like. In addition, the microchannel device of the present invention, especially the microchannel device of the present invention formed of the stimuli-sensitive gel, may have a reinforcing portion formed of other material to get an enough device strength, and the like.

Also, the microchannel device of the present invention may have a portion that has a function of reaction, mixing, separation, purification, analysis, cleaning, or the like according to the application, in addition to the above stimulation giving portion.

For example, a fluid feed port for feeding the fluid to the microchannel device, a fluid recovery port for recovering the fluid from the microchannel device, etc. may be provided to the microchannel device of the present invention, if necessary

Also, preferably a plurality of microchannel devices of the present invention can be used in combination according to the application. Otherwise, preferably the microchannel device of the present invention can be combined with a device having a function of reaction, mixing, separation, purification, analysis, cleaning, or the like, another microchannel device such as a fluid feeding device, a fluid recovering device, or the like, and the like to build up a microchemical system.

A method of manufacturing the microchannel device of the present invention is not particularly limited. But preferably the following method can be listed.

As the method of manufacturing the microchannel device in which the stimuli-sensitive gel is modified on the inner wall of the microchannel, preferably a manufacturing method including the step of forming the device in which the microchannel is formed (referred also to as the “channel forming step” hereinafter), the step of modifying the reactive group on the inner wall of the microchannel (referred also to as the “inner wall modifying step” hereinafter), and the step of forming the stimuli-sensitive gel on the inner wall of the microchannel by causing the reactive group to react with a precursor composition of the stimuli-sensitive gel (referred also to as the “gel forming step” hereinafter) can be illustrated.

As the method of forming the microchannel in the channel forming step, no limitation is imposed particularly and, for example, the publicly-known method can be employed. The microchannel can be manufactured by the micromachining method, for example. As the micromachining method, there are a method using the LIGA technology using an X-ray, a method of processing a resist portion as a structure by the photolithography method, a method of forming an opening portion in the resist by the etching, a micro electric discharge machining process, a laser beam machining process, and a mechanical micro cutting process using a micro tool made of a hard material such as a diamond, or the like. These technologies may be applied solely or in combination.

Among these technologies, preferably the mechanical micro cutting process should be employed when the resin is employed.

As the method of modifying the reactive group on the inner wall in the inner wall modifying step, no limitation is imposed particularly. When the base material of the microchannel device is formed of the glass, a method of causing the silane compound having the reactive group to react with the surface of the inner wall can be considered, for example. Also, when the base material is formed of the resin, a method of causing the compound having at least the group that can react with the functional group in the resin and the reactive group to react with the surface of the inner wall can be considered, for example.

The gel forming step is the step of forming the microchannel to the inner wall of which the stimuli-sensitive gel is bonded by the covalent bond by causing the precursor composition of the stimuli-sensitive gel to react with the reactive group.

The precursor composition of the stimuli-sensitive gel can contain the monomer, the crosslinking agent, the reaction initiator, the solvent, and the like in answer to the desired stimuli-sensitive gel to form the stimuli-sensitive gel.

The reactive group can be selected adequately in response to the desired stimuli-sensitive gel. For example, when the stimuli-sensitive gel is formed by the radical polymerization reaction, preferably the radical polymerizing group should be used as the reactive group. Also, when the stimuli-sensitive gel is formed by the cationic polymerization reaction, preferably the cationic polymerizing group should be used as the reactive group.

As the reactive group, preferably the ethylene unsaturated group as the radical polymerizing group, the cyclic ether group as the cationic polymerizing group, and the like can be listed. More preferably vinyl group, epoxyl group, oxetanyl group, etc. can be listed from aspects of the reactivity, etc.

As the method of manufacturing the microchannel device whose microchannel is formed of the stimuli-sensitive gel, no limitation is imposed particularly. In this case, the method containing the step of forming the microchannel on at least one surface of the stimuli-sensitive gel substrate and the step of blocking the surface of the stimuli-sensitive gel substrate, on which the microchannel is formed, by the stimuli-sensitive gel, the method containing the step of forming the microchannel in the stimuli-sensitive gel, and the like can be listed.

As the method of forming the microchannel on the surface of the stimuli-sensitive gel or in the inside thereof, no limitation is imposed particularly. In this case, in addition to the photolithography method and the etching method, as mentioned above, a method of obtaining the stimuli-sensitive gel on the surface of which or in the inside of which the microchannel is formed by manufacturing a mold of the microchannel and then forming the stimuli-sensitive gel in the mold, and the like can be employed.

As the method of blocking the surface of the stimuli-sensitive gel substrate on which the microchannel is formed by the stimuli-sensitive gel, no limitation is imposed particularly. In this case, a method of adhering the substrate surface to another stimuli-sensitive gel substrate by a monomer component constituting the stimuli-sensitive gel, the adhesive, etc., a method of filling the microchannel with an easily removable substance, then forming the stimuli-sensitive gel thereon or adhering the microchannel to another stimuli-sensitive gel substrate, and then removing the substance filled in the microchannel, and the like can be employed.

### EXAMPLES

The present invention will be explained with reference to Examples hereunder. But these Examples should not be interpreted to restrict the present invention at all.

### Example 1

### Light Stimulation

An isooctane solution of 0.1M chlorodimethylvinylsilane was filled in the microchannel (Standard Chip manufactured by Institute of Microchemical Technology, ICC-IRO1, groove width 200 μm, groove depth 90 μm, channel length 60 mm) made of the glass, and then was held for 10 hours in a sealed state as it was. Thus, the vinyl group was modified on the glass surface. After the solution was exhausted, the microchannel was rinsed with hexane or methanol.

Acrylamide 12 wt %, 4-acryloylaminoazobenzene 2 wt %, crosslinking agent N,N′-methylenebisacrylamide (BIS) (manufactured by Wako Pure Chemical Industries, Ltd) 0.02 wt %, and initiator acetaminophen (manufactured by Wako Pure Chemical Industries, Ltd) 0.2 wt % were dissolved in dioxin 51.7 wt % to execute the nitrogen substitution completely. When the inner wall of the microchannel on which the vinyl group was modified was coated with this solution and then the photopolymerization was executed by irradiating a UV light, the microchannel whose inner wall was covered with the polymer gel was obtained.

When a water was filled in the resultant microchannel, the coated gel was in its shrunk state. When a light of 366 nm was spot-irradiated by using a high-pressure mercury lamp and a color filter, the gel was swelled by the trans-cis transfer of the azobenzene group and the channel was blocked at the portion onto which the light was irradiated (FIG. 1). The blocking of the channel by the light irradiation could be realized at any location. Also, the gel was returned to its shrunk state by the visible light irradiating environment or thermal relaxation. This swelling/shrinking behavior was completely reversible.

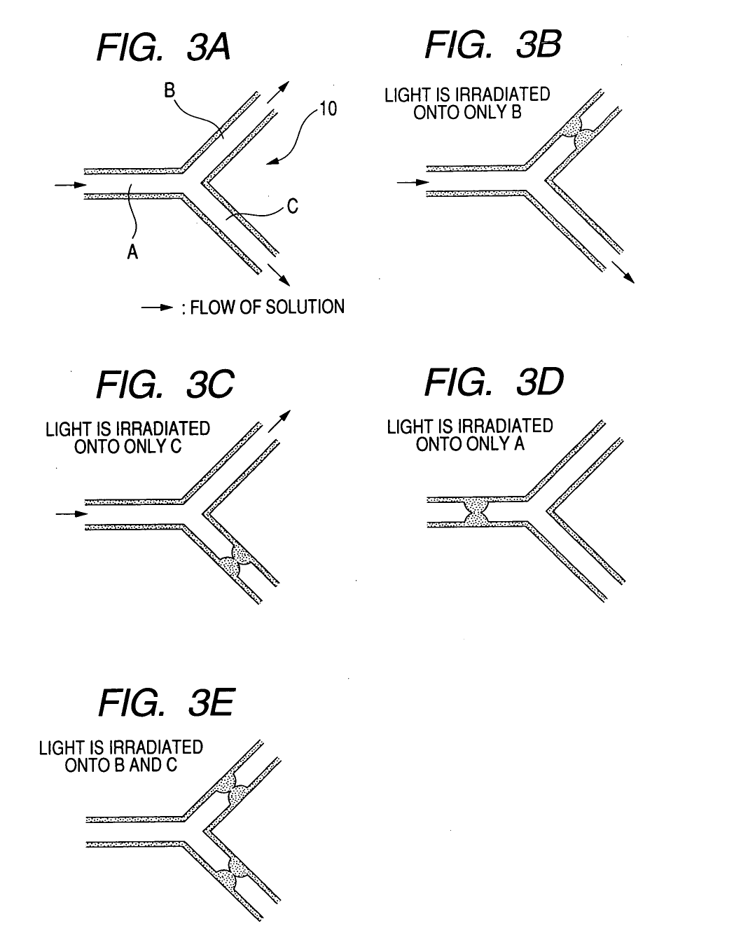

Also, while using the microchannel (Standard Chip manufactured by Institute of Microchemical Technology, ICC-SYO5) shown in FIG. 3A, the above process was applied to the Y-shaped microchannel 10 in which one channel (channel 1 (A)) was separated into two channels (channel 2 (B) and channel 3 (C)), and then an aqueous solution was passed through the microchannel. In a normal condition, a flow rate was (channel 1)=(channel 2)+(channel 3). Here, when a light of 366 nm was spot-irradiated onto the channel 2, the gel was swelled on the irradiation portion, so that the solution was flown into only the channel 3 (FIG. 3B). Also, when the similar light was similarly irradiated only onto the channel 3, the solution was flown into only the channel 2 (FIG. 3C). In addition, when a light was irradiated onto the channel 1 (FIG. 3D) or a light was irradiated onto the channel 2 and the channel 3 (FIG. 3E), the solution was not passed at all. Also, when a light irradiating time was shortened, the gel was brought into its semi-swelled state, so that a flow rate could be suppressed (not shown). Also, in all cases, the gel was returned to its shrunk state by the visible light irradiating environment or thermal relaxation. This swelling/shrinking behavior was completely reversible.

In this manner, according to the present approach, a flow could be controlled arbitrarily by giving the stimulation to any portion of the microchannel.

### Example 2

### Electrical Stimulation

A 0.5M sulfuric acid aqueous solution was filled in the microchannel (groove width 1000 μm, groove depth 1000 μm, channel length 50 mm) made of glass, in which microelectrodes (working rods) were aligned on the wall surface of the channel, and then, and then the anode oxidation was executed by applying 1.9 V (to SCE) to the electrodes (5 minutes). Then, the sweep was repeated until the cyclic voltammogram became stable in a range of −0.1 to 1.1 V (to SCE), and then the microchannel was held as it was until a current value became constant while keeping a voltage at 1.1 V. The hydroxyl group could be introduced on the electrodes by the above operations. Then, the microchannel was rinsed and then an isooctane solution of 0.1M chlorodimethylvinylsilane was filled in the microchannel and then the microchannel was held for 10 hours in a sealed state as it was. Thus, the vinyl group was modified on the glass surface and the electrode surfaces. After the solution was exhausted, the microchannel was rinsed with hexane or methanol.

N-isopropylacrylamide 12 wt %, acrylic acid 2 wt %, triethylamine 1.5 times in molar quantity equivalent, crosslinking agent N,N′-methylenebisacrylamide (BIS) (manufactured by Wako Pure Chemical Industries, Ltd) 0.02 wt %, and initiator acetaminophen (manufactured by Wako Pure Chemical Industries, Ltd) 0.2 wt % were dissolved in a water 50 wt % to execute the nitrogen substitution completely. When this solution was filled in the inner wall of the microchannel on which the vinyl group was modified and then the photopolymerization was executed by irradiating the UV light, the microchannel whose inner wall was covered with the polymer gel was obtained after the solution was rinsed.

When N,N-dimethyl formamide (DMF) was filled in the resultant microchannel and all working electrodes were kept at −20 V, the coated gel was in its shrunk state. When an electrode potential in any position was set to +20 V, the gel was swelled and the channel was blocked. The blocking of the microchannel by this electrical stimulation could be realized at any location. Also, this swelling/shrinking behavior was completely reversible.

### Example 3

### Any Chemical Species, Glucose Response

An isooctane solution of 0.1M chlorodimethylvinylsilane was filled in the microchannel (Standard Chip manufactured by Institute of Microchemical Technology, ICC-IRO1, groove width 200 μm, groove depth 90 μm, channel length 60 mm) made of the glass, and then was held for 10 hours in a sealed state as it was. Thus, the vinyl group was modified on the glass surface. After the solution was exhausted, the microchannel was rinsed with hexane or methanol.

N-isopropylacrylamide 12 wt %, 3-acrylamide phenylboronic acid 2 wt %, crosslinking agent N,N′-methylenebisacrylamide (BIS) (manufactured by Wako Pure Chemical Industries, Ltd) 0.02 wt %, and initiator acetaminophen (manufactured by Wako Pure Chemical Industries, Ltd) 0.2 wt % were dissolved in a dimethyl sulfoxide (DMSO) 55 wt % to execute the nitrogen substitution completely. When this solution was filled in the inner wall of the microchannel on which the vinyl group was modified, then the photopolymerization was executed by irradiating the UV light, and then the solution was rinsed, the microchannel whose inner wall was covered with the polymer gel was obtained.

When a 0.1 M N-cyclohexyl-2-aminoethanesulfonic acid (CHES) buffer was filled at 28° C. in the resultant microchannel, the coated gel was in its shrunk state. Then, a glucose aqueous solution is supplied herein while increasing gradually a glucose concentration. The gel started to swell from around 3 mM of the glucose concentration, and a flow rate is reduced gradually with a temperature rise. When the glucose concentration came up to about 20 mM, the channel was almost blocked. Since the gel was shrunk by increasing a temperature, the gel went back to its initial state when the solution of a low glucose concentration was flown through the microchannel. This swelling/shrinking behavior was completely reversible.

### Example 4

### Any Chemical Species, Molecular Imprinting Method

An isooctane solution of 0.1M chlorodimethylvinylsilane was filled in the microchannel (Standard Chip manufactured by Institute of Microchemical Technology, ICC-IRO1, groove width 200 μm, groove depth 90 μm, channel length 60 mm) made of the glass, and then was held for 10 hours in a sealed state as it was. Thus, the vinyl group was modified on the glass surface. After the solution was exhausted, the microchannel was rinsed with hexane or methanol.

N-isopropylacrylamide 12 wt %, acrylic acid 2 wt %, norephedrine hydrochloride 2 wt %, crosslinking agent N,N′-methylenebisacrylamide (BIS) (manufactured by Wako Pure Chemical Industries, Ltd) 0.02 wt %, and initiator acetaminophen (manufactured by Wako Pure Chemical Industries, Ltd) 0.2 wt % were dissolved in dioxane 51.7 wt % to execute the nitrogen substitution completely. When this solution was filled in the inner wall of the microchannel on which the vinyl group was modified, then the photopolymerization was executed by irradiating the UV light, and then the solution was rinsed, the microchannel whose inner wall was covered with the polymer gel was obtained. The norephedrine hydrochloride was extracted by a 10% acetic acid aqueous solution, and then a resultant structure was rinsed with a pure water. The resultant gel was a host gel on which the guest molecules (in this case, norephedrine hydrochloride) existing at the time of polymerization was imprinted and which stored the structure and had the specific orientation.

When the water was filled in the resultant microchannel and was held at 50° C., the gel was in its shrunk state and also an ordinary flow rate could be kept. Then, a norephedrine hydrochloride aqueous solution was fed while increasing gradually a norephedrine hydrochloride concentration. The gel started to swell from near 50 mM of a norephedrine hydrochloride concentration, and a flow rate was reduced gradually in response to a temperature rise. When a norephedrine hydrochloride concentration reached about 100 mM, the microchannel was substantially blocked. Also, the gel did not swell even when an aqueous solution of adrenalin hydrochloride, norepinephrine hydrochloride, or the like serving as the similar substance to norephedrine hydrochloride was fed, so that it has been confirmed that the gel responds only to the substance added at the time of polymerization. In addition, even when other material was added at the time of polymerization, the gel responded specifically to this material. Also, it has been confirmed that this swelling/shrinking behavior is completely reversible.

### Example 5

### Temperature Stimulation

An isooctane solution of 0.1M chlorodimethylvinylsilane was filled in the microchannel (Standard Chip manufactured by Institute of Microchemical Technology, ICC-IRO1, groove width 200 μm, groove depth 90 μm, channel length 60 mm) made of the glass, and then was held for 10 hours in a sealed state as it was. Thus, the vinyl group was modified on the glass surface. After the solution was exhausted, the microchannel was rinsed with hexane or methanol.

Acrylamide 12 wt %, crosslinking agent N,N′-methylenebisacrylamide (BIS) (manufactured by Wako Pure Chemical Industries, Ltd) 0.02 wt %, and initiator acetaminophen (manufactured by Wako Pure Chemical Industries, Ltd) 0.2 wt % were dissolved in dioxin 51.7 wt % to execute the nitrogen substitution completely. When the inner wall of the microchannel on which the vinyl group was modified was coated with this solution, then the photopolymerization was executed by irradiating a UV light, and then the microchannel was rinsed, the microchannel whose inner wall was covered with the acrylamide gel was obtained. An acrylate aqueous solution 3 wt % to which an initiator and an accelerator were added was filled in the microchannel, and the polymerization reaction was executed for two hours. Extra polyacrylic acid and unreacted substance were rinsed with a pure water after the polymerization. Polyacrylamide/poly(acrylic acid) semi IPN (Interpenetrating Networks) gel was coated on the wall surface of the microchannel by above operations. This gel swelled at a high temperature and shrunk at a low temperature.

When a water was filled in the resultant microchannel, the coated gel was in its shrunk state at a room temperature. When the gel was heated locally by using a laser, the gel was swelled immediately only in the irradiated portion and the channel was blocked. The blocking of the channel by this light irradiation could be applied to any location. Also, the gel was returned to its shrunk state immediately when the laser irradiation was stopped. This swelling/shrinking behavior was completely reversible.

What is claimed is:

1. A microchannel device comprising:
a microchannel that comprises a stimuli-sensitive gel and is adjusted by giving a stimulation species to the stimuli-sensitive gel.

2. A microchannel device as claimed in claim 1, wherein the stimuli-sensitive gel is bound chemically to at least a part of an inner wall of the microchannel.

3. A microchannel device as claimed in claim 1, wherein the stimulation species is a light.

4. A microchannel device as claimed in claim 1, wherein the stimulation species is an electricity.

5. A microchannel device as claimed in claim 1, wherein the stimulation species is an arbitrary chemical species.

6. A microchannel device as claimed in claim 1, wherein the stimulation species are temperature changes.

7. A microchannel device as claimed in claim 1, wherein the stimuli-sensitive gel is one of a bridged material of a polymer compound having an azo group, a bridged material of a copolymer consisting of a phenylboronic acid monomer and an ethylene unsaturated monomer, and a bridged material of an N-alkyl substitution (meta)acrylamide copolymer.
